(19) United States
(12) Patent Application Publication
(10) Pub. No.: US 2010/0018962 A1
(43) Pub. Date: Jan. 28, 2010

(54) Temperature control device for a fuel heater element

(76) Inventors: Daniel F. Kabasin, Rochester, NY (US); David J. Trapasso, Bloomfield, NY (US)

Correspondence Address: Paul L. Marshall, Esq.;Delphi Technologies, Inc., Mail Code 480410202, P.O. Box 5052, Troy, MI, 48007, US

(21) Appl. No.: 12/220,274

(22) Filed: Jul. 23, 2008

(51) Int. Cl. H05B 3/02; G05D 23/00

(52) U.S. Cl. 219/482; 700/300

(57) ABSTRACT

A heater temperature closed-loop control circuit includes a basic Wheatstone bridge circuit with an integral heater element, an amplifier integrated circuit receiving a resultant bridge voltage and controlling an amplifier in correlation with the resistance of the heater element, and a supply voltage provided to the Wheatstone bridge circuit when said transistor is turned on. A thermistor may be integrated into the bridge circuit for compensation of ambient temperatures. While the closed-loop control circuit provides a simple and inexpensive method to provide temperature control and protection to any heater element having a positive temperature coefficient, the control circuit may be especially useful for applications in the automotive industry, for example, to control the temperature of a heated fuel injector or of a heated target that generates vapor from liquid fuel injected upon it.

### TECHNICAL FIELD

The present invention relates to a device for heating and vaporizing liquid fuels; and more particularly, to an apparatus and method for monitoring and controlling heater element temperatures of the heating device.

### BACKGROUND OF THE INVENTION

Fuel-injected internal combustion engines fueled by liquid fuels, such as gasoline, diesel, and by alcohols, in part or in whole, such as ethanol, methanol, and the like, are well known. Internal combustion engines typically produce power by controllably combusting a compressed fuel/air mixture in a combustion cylinder. In a Diesel cycle engine, intake air is first compressed by a piston in a cylinder, then fuel is injected into the cylinder for combustion by the compressed, heated air. For spark-ignited engines, both fuel and air first enter the cylinder where an ignition source, such as a spark plug, ignites the fuel/air charge, typically just before the piston in the cylinder reaches top-dead-center of its compression stroke. In a spark ignited engine fueled by gasoline, ignition of the fuel/air charge readily occurs except at extremely low temperatures because of the relatively low flash point of gasoline. (The term “flash point” of a fuel is defined herein as the lowest temperature at which the fuel can form an ignitable mixture in air). However, in a spark ignited engine fueled by alcohols such as ethanol, or mixtures of ethanol and gasoline having a much higher flash point, ignition of the fuel/air charge may not occur at all under cooler climate conditions. For example, ethanol has a flashpoint of about 12.8° C. Thus, starting a spark-ignited engine fueled by ethanol can be difficult or impossible under cold ambient temperature conditions experienced seasonally in many parts of the world. The problem is further exacerbated by the presence of water in such mixtures, as ethanol typically distills as a 95/5% ethanol/water azeotrope.

In many geographic areas, it is highly desirable to provide some means for enhancing the cold starting capabilities of such spark-ignited engines fueled by ethanol or other blends of alcohol. There are currently several approaches to aid cold starting of such engines. For example, some engines are equipped with an auxiliary gasoline injection system for injecting gasoline into the fuel/air charge that is utilized under cold start conditions. The use of such auxiliary system adds cost to the vehicle and to the operation of the vehicle and may increase the maintenance required for the engine.

Another approach to aid cold starting of spark-ignited engines fueled by ethanol or other blends of alcohol is to pre-heat the fuel before being ignited in the combustion chamber. One method of pre-heating the fuel is to spray the fuel directly onto a heat source before being mixed with air, causing the liquid fuel to vaporize upon contact with the heat source before being ignited by the spark.

Yet another method of pre-heating the fuel is to provide a heat source on the outside surface of a fuel injector body proximate to the injector tip to pre-heat the fuel. The key to implementing either of the last two methods is having sufficient heater power and heater surface area to transfer heat to the fuel. One current approach includes applying a heater formed of an electrically resistive material, such as a thick film heater element, to the injector or the spray target. When electric current is passed through the electrically resistive material, heat is generated, which is passed through the wall of the fuel injector or at the target to elevate the temperature of the affected fuel. In a thick film heater element for example, with a constant voltage applied across the element, the current flow through the element is inversely proportional to the temperature of the element. Thus, as the temperature of the element increases, the resistance of the element also increases. Such a heater element, wherein as the temperature of the element increases the resistance of the element also increases, is referred to herein as a heater element having a “positive temperature coefficient”.

Various open-loop methods have been suggested or employed to control the temperature of a positive temperature coefficient heater element for generating fuel vapor. In one open-loop set up, the heater element circuit includes a fixed resistor wired in series with the element. Such open-loop methods cannot compensate for variations in engine intake air flows, heater element tolerances, ambient temperature, or voltage supplies and, subsequently, the amount of vapor generated will fluctuate.

Furthermore, the on-board-diagnostics standard in many countries requires the vehicle's control system to not only detect when a problem with a system component occurs but also to determine the fault location and cause. For example, in the case of the heated fuel injector, failure of the injector, heater, fuse, fuel supply, injector driver, or heater driver may all have the same effect—failure to start the engine. This is unsatisfactory for diagnostic purposes as all of these potentially failed items would have to be checked to isolate the failure. In addition, even though the vehicle may start and run with the failed condition, the tail pipe emissions may be above acceptable limits—a problem that needs to be more easily detectable.

What is needed in the art is a device and method to control the temperature of a heater element that inherently compensates for various tolerances as well as to enable determination of component failure and cause for diagnostic purposes.

It is a principal object of the present invention to provide a simple and inexpensive closed-loop method that enables controlling the temperature of a heater element, provides over heating protection for such an element, and can be utilized for on-board-diagnostics.

### SUMMARY OF THE INVENTION

Briefly described, a heater element having a positive temperature coefficient, is incorporated into a simple Wheatstone bridge circuit. The heater element may be, for example, a thick film heater.

The values of the bridge resistances are selected such that a pre-selected target temperature of the heater element results in a balanced bridge. If the temperature of the heater element is below the target temperature, then the imbalance of the Wheatstone bridge turns on a transistor, thereby applying power to the heater element to increase its temperature. If the heater element temperature is above the target temperature, then the transistor is turned off, preventing a further supply of power to the heater, thereby reducing the temperature of the element. Consequently, the analog Wheatstone bridge and its control integrated circuit self-regulate the target temperature of the heater element in a closed-loop.

By integrating the resistance of the heater element itself into the Wheatstone bridge and by providing a closed-loop circuit, the temperature of the heater element can be controlled to a pre-selected value independent of battery voltage and fuel flow. The temperature feedback of the heated element is inherently part of the Wheatstone bridge balance, and eliminates the need for a separate, discrete temperature sensor, as utilized in the known prior art.

In one aspect of the invention, a thermistor selected according to the proper bridge resistance is integrated into the Wheatstone bridge such that the bridge can be temperature compensated for ambient temperatures.

In another aspect of the invention, software algorithms are utilized in conjunction with the heater temperature control circuit making it possible to detect and localize various component failures of an engine.

### BRIEF DESCRIPTION OF THE DRAWINGS

The present invention will now be described, by way of example, with reference to the accompanying drawings, in which:

FIG. 1 is a schematic diagram of a heater temperature control circuit, in accordance with the invention; and

FIG. 2 is a schematic circuit diagram for scaling an amplifier integrated circuit, in accordance with the invention.

Corresponding reference characters indicate corresponding parts throughout the diagrams. The exemplifications set out herein illustrate various possible embodiments of the invention, including one preferred embodiment in one form, and such exemplifications are not to be construed as limiting the scope of the invention in any manner.

### DESCRIPTION OF THE PREFERRED EMBODIMENTS

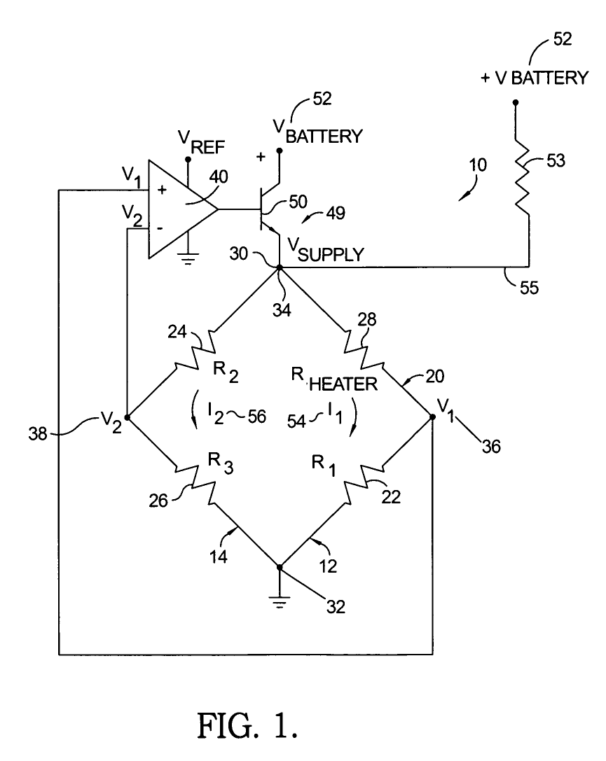

Referring to FIG. 1, a heater temperature control circuit 10 in accordance with the invention includes a bridge circuit 20, an amplifier integrated circuit 40, and a transistor 50. Bridge circuit 20 has two branches 12 and 14 and includes four resistors 22, 24, 26, and 28, wherein resistors 22 and 28 represent branch 12, and wherein resistors 24 and 26 represent branch 14. Bridge circuit 20 further includes a supply voltage node 30 and a ground node 32. Bridge circuit 20 is connected to an input of amplifier integrated circuit 40 and an output of amplifier integrated circuit 40 is connected to a base terminal of transistor 50. A switching device 49 such as transistor 50 wherein a collector terminal of transistor 50 is connected to a battery voltage V_{battery} 52 and an emitter terminal of transistor 50 is connected to supply voltage node 30 of bridge circuit 20. A separate branch 55 of control circuit 10 provides battery voltage V_{battery} 52, through resistor 53 to supply voltage node 30. The resistance of resistor 53 is selected to be greater than the internal resistance of transistor 50, when the transistor is on. Transistor 50 is controlled by amplifier integrated circuit 40. When transistor 50 is turned on, a preferably constant supply voltage V_{supply} 34 that is essentially equal to battery voltage V_{battery} 52 is provided to bridge circuit 20 at supply voltage node 30. When transistor 50 is turned off, the supply voltage V_{supply} 34 is disconnected from bridge circuit 20 at supply voltage node 30. Accordingly, heater temperature control circuit 10 is a closed-loop circuit.

Bridge circuit 20 is preferably a basic Wheatstone bridge circuit. Amplifier integrated circuit 40 is an operational amplifier, such as a differential amplifier. Transistor 50 may be, for example, a bipolar or field effect transistor.

First branch 12 includes a first resistor 22 having a first resistance R₁ and a heater element 28 having a fourth resistance Rₕₑₐₜₑᵣ. Second branch 14 includes a second resistor 24 having a second resistance R₂ and a third resistor 26 having a third resistance R₃. Supply voltage node 30 is positioned between second resistor 24 and heater element 28, and ground node 32 is positioned between first resistor 22 and third resistor 26. Heater element 28 may be, for example, a thick film heater or any other heater element that has a positive temperature coefficient. Thick film heater elements can be made to close manufacturing tolerances, having a part to part resistance variation, for example, of less than 5%. Because of this, it is possible to use the measured resistance Rₕₑₐₜₑᵣ of a thick film heater element to estimate the temperature of the device 28.

When bridge circuit 20 is balanced, the ratio of the resistances (Rₕₑₐₜₑᵣ/R₁) of the first branch 12 is equal to the ratio of the resistances (R₂/R₃) of the second branch 14. As a result, a node voltage V₁ 36 of the first branch measured at the node between heater element 28 and first resistor 22 is equal to a node voltage V₂ 38 of the second branch measured at the node between second resistor 24 and third resistor 26.

In one aspect of the invention, bridge circuit 20 is designed such that a pre-selected target temperature of heater element 28 and a corresponding resistance Rₕₑₐₜₑᵣ results in a balanced bridge circuit 20, where node voltage V₁ 36 is equal to node voltage V₂ 38. In this case, the resultant bridge voltage ΔV is zero volts: ΔV=V₁−V₂=0.

As shown in FIG. 1, node voltage V₁ 36 and node voltage V₂ 38 are the inputs for amplifier integrated circuit 40. When bridge circuit 20 is balanced and node voltage V₁ 36 is equal to a node voltage V₂ 38, amplifier integrated circuit 40 zeros out the voltage applied to transistor 50, which turns off the transistor 50 and voltage to the heater element.

If the temperature of the heater element 28 is below the pre-selected target temperature, the corresponding resistance Rₕₑₐₜₑᵣ decreases, which results in node voltage V₁ 36 being closer in value to input voltage V_{supply} 34 and greater than node voltage V₂ 38. This imbalance of bridge circuit 20 results in a positive resultant bridge voltage ΔV and causes amplifier integrated circuit 40 to apply a positive voltage to transistor 50. As a result, transistor 50 is turned on and input voltage V_{supply} 34 is supplied to bridge circuit 20 and, consequently, to heater element 28, causing the temperature of heater element 28 to increase to the pre-selected target temperature.

If the temperature of heater element 28 is above the pre-selected target temperature, the corresponding resistance Rₕₑₐₜₑᵣ 28 increases, which results in node voltage V₁ 36 being closer in value to ground and less than node voltage V₂ 38. This imbalance of bridge circuit 20 results in a negative resultant bridge voltage ΔV and causes amplifier integrated circuit 40 to apply a zero voltage to transistor 50. As a result, transistor 50 is turned off and no input voltage V_{supply} 34 is supplied to bridge circuit 20 and, consequently, to the heater element causing the temperature of the heater element to decrease to the pre-selected target temperature.

If the temperature of the heater element 28 falls back below the set target temperature, transistor 50 is turned back on and reconnects bridge circuit 20 to a power source providing voltage V_{battery} 52. Basically, whenever the temperature of heater element 28 is below the pre-selected target temperature, transistor 50 turns on and allows current to flow into bridge circuit 20 and whenever the temperature of heater element 28 is above the pre-selected target temperature, transistor 50 turns off and current stops flowing to bridge circuit 20. Heater temperature control circuit 10 toggles between these two states to maintain resistance Rₕₑₐₜₑᵣ of heater element 28 and, therefore, to maintain the pre-selected target temperature of heater element 28. Consequently, the analog bridge circuit 20 and its control amplifier integrated circuit 40 operates in closed-loop to maintain the pre-selected target temperature of heater element 28. As can be seen, the temperature of heater element 28 can be controlled by heater temperature control circuit 10 to a pre-selected value independent of variation of operational parameters including, for example, the battery voltage and the fuel flow.

Resistor 53 in branch 55 permits a low level of current (insignificant to heat heater element 28) to the bridge so that amplifier integrated circuit 40 can sense node voltage V₁ 36 and node voltage V₂ 38 when transistor 50 is off and not supplying current to the bridge. When transistor 50 is on, its internal resistance is much lower than the resistance of resistor 53. Transistor 50 thereby supplies a sufficiently higher current to heat heater element 28.

Still referring to FIG. 1, the first resistor 22, second resistor 24, and third resistor 26 of bridge circuit 20 should preferably be precision resistors to minimize the system error. First resistor 22 and third resistor 26 of bridge circuit 20 have known resistances R₁ and R₃, respectively. Second resistor 24 may have a known resistance R₂ or may be a thermistor such that bridge circuit 20 may be temperature compensated for ambient temperatures. First resistor 22 may have a relatively low resistance R₁ so that the current flowing through heater element 28 can be maximized. Second resistor 24 and third resistor 26 may have relatively high resistances R₂ and R₃, respectively, compared to resistance R₁ of first resistor 22 and resistance Rₕₑₐₜₑᵣ of heater element 28. For example, second resistor 24 and third resistor 26 may have resistances R₂ and R₃, respectively, in the kilo ohms range while first resistor 22 and heater element 28 may have resistances R₁ and Rₕₑₐₜₑᵣ, respectively, in the milliohms range such that a current I₁ 54 flowing through the first branch of bridge circuit 20 is significantly greater than a current I₂ 56 flowing through the second branch of bridge circuit 20.

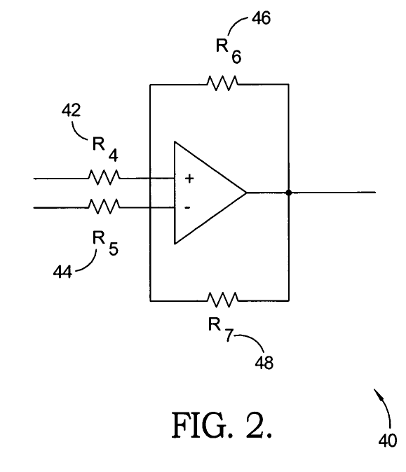

Referring to FIG. 2, the scaling for amplifier integrated circuit 40 may be set with resistors 42, 44, 46, and 48 such that the gain of amplifier integrated circuit 40 sets the reaction and recovery rate for the temperature changes of heater element 28 and for the corresponding changes in resistance Rₕₑₐₜₑᵣ. Any combination of resistors 42, 44, 46, and 48 may be employed to set the proper gain of amplifier integrated circuit 40 to result in a desired reaction time. If the scaling of amplifier integrated circuit 40 with resistors 42, 44, 46, and 48 sets an offset within heater temperature control circuit 10, any conventional analog capacitors may be integrated into circuit 10 if required. Instead of using capacitors, it may further be possible to employ a proportional-integral-derivative (PID) controller.

While heater temperature control circuit 10 provides a simple and inexpensive method to control the temperature of any heater element having a positive temperature coefficient and to provide overheat protection for such a heater element, heater temperature control circuit 10 may be especially useful for applications in the automotive industry. For example, control circuit 10 may be used to control the temperature of a heated fuel injector or of a heated target used to generate vapor from sprayed, liquid fuel. Control circuit 10 may also protect such heater elements from over heating.

In addition, control circuit 10 may be utilized for On Board Diagnostics (OBD) of a motor vehicle to detect when component failure or malfunction occurs and to identify the fault location. In the case of a heated injector, a failure of the injector, the heater element 28, the fuse, the fuel supply, the injector driver, the heater driver can all have the same general failure effect—failure to start the engine. Detection of such a general failure is of little use for diagnostic purposes as numerous components would have to be checked in order to isolate the cause of the failure. In another case, the vehicle may start and run but the tailpipe emissions may, nevertheless, exceed emission limits.

By utilizing software algorithms in conjunction with heater temperature control circuit 10 as described above, it is possible to more precisely identify and isolate such failures. For example, in the case where the heater element is integrated in an injector, if the heater element 28 on one of the injectors fails, the resistance Rₕₑₐₜₑᵣ would be read by the diagnostic system as being infinite and transistor 50 would turn off voltage to the heater element. The diagnostic system, reading this, could pin point the problem to a specific failed injector, and identify the failure cause. In another example, if fuel pressure to the injector is reduced, for example due to a pump malfunction, the temperature of all of the heater elements 28 would increase from a reduction of fuel flow through the injectors and a corresponding decrease in the heat transfer rate away from the heater elements. The increase of the heater element temperatures above a set target temperature would lead to an abnormally increased resistance Rₕₑₐₜₑᵣ in all of the heater temperature control circuits 10. The resistance increase in all heaters would be sensed by the diagnostic system thereby triggering the necessary warning or remedial action. In still another example, in some cases where heated injectors are used to reduce emissions regardless of ambient temperatures and fuel flash points, the heater element diagnostic system may be linked with the vehicle's engine sensors/emission control devices to alert the driver of an emission failure.

While switching device 49, and more specifically transistor 50, is exemplified as an NPN transistor, it is understood that the transistor may be, for example, a PNP, an FET or an IGBT transistor. Moreover, any type of switching device suitable for the application other than a transistor is contemplated by the invention.

While the above examples demonstrate a useful application of the invention for internal combustion engines, the application of heater temperature control circuit 10 is not limited to such applications. Heater temperature control circuit 10 may be useful for controlling, monitoring, and protecting any heater element 28 that has a positive temperature coefficient.

It should be understood that numerous changes may be made within the spirit and scope of the inventive concepts described, including but not limited to other configurations, materials, and locations of vaporization elements. Accordingly, it is intended that the invention not be limited to the described embodiments, but will have full scope defined by the language of the following claims.

What is claimed is:

1. A heater temperature closed-loop control circuit, comprising;
a Wheatstone bridge circuit;
a heater element integrated into said Wheatstone bridge circuit, said heater element having a positive temperature coefficient;
a switching device receiving a resultant bridge voltage of said Wheatstone bridge circuit dependent upon said resistance of said heater element; and
a supply voltage provided to said Wheatstone bridge circuit when said switching device is turned on.

2. The closed-loop control circuit of claim 1, further including an amplifier integrated circuit receiving said resultant bridge voltage of said Wheatstone bridge circuit, wherein said switching device is a transistor controlled by said amplifier integrated circuit dependent upon said resistance of said heater element.

3. The closed-loop control circuit of claim 1, wherein said Wheatstone bridge circuit further includes a first resistor having a known first resistance, a second resistor having a known or a temperature depending second resistance, and a third resistor having a known third resistance.

4. The closed-loop control circuit of claim 3, wherein said heater element and said first resistor form a first branch of said Wheatstone bridge circuit, and wherein said second and said third resistor form a second branch of said Wheatstone bridge circuit.

5. The closed-loop control circuit of claim 3, wherein a ratio of said resistance of said heater element to said first resistance is equal to a ratio of the said second resistance to said third resistance when said Wheatstone bridge circuit is balanced and when a pre-selected temperature of said heater element is reached.

6. The closed-loop control circuit of claim 1, wherein said heater element is a thick film heater element.

7. The closed-loop control circuit of claim 2, wherein said transistor includes a base terminal connected to said amplifier integrated circuit, an emitter terminal connected to said Wheatstone bridge circuit, and a collector terminal connected to a battery voltage, and wherein said battery voltage is essentially equal to said supply voltage.

8. The closed-loop control circuit of claim 1, wherein said Wheatstone bridge circuit is in a balanced state when said resistance of said heater element has a pre-selected value that correlates with a pre-selected temperature of said heater element.

9. The closed-loop control circuit of claim 2, wherein said amplifier integrated circuit turns said transistor on when said resistance of said heater element is below a pre-selected value that correlates with a pre-selected temperature of said heater element.

10. The closed-loop control circuit of claim 2, wherein said amplifier integrated circuit turns said transistor off when said resistance of said heater element is at or above a pre-selected value that correlates with a pre-selected temperature of said heater element.

11. A heater temperature closed-loop control circuit, comprising:
a bridge circuit including two branches and a supply voltage node positioned between said two branches;
four resistors equally distributed between said two branches, wherein one of said resistors is represented by a heater element having a positive temperature coefficient;
an amplifier integrated circuit connected to said bridge circuit and receiving a resultant bridge voltage at an input;
a transistor including a base terminal, a collector terminal, and an emitter terminal, wherein said base terminal is connected to an output of said amplifier integrated circuit, and wherein said emitter terminal is connected to said supply voltage node; and
a voltage connected to said collector terminal of said transistor;
wherein said amplifier integrated circuit controls said transistor in correlation to a temperature of said heater element; and
wherein a supply voltage that is essentially equal to said connected voltage is supplied to said bridge circuit and said heater element via said supply voltage node when said transistor is turned on.

12. The closed-loop control circuit of claim 11 wherein said connected voltage is a battery voltage.

13. The closed-loop control circuit of claim 11, wherein said amplifier integrated circuit turns said transistor on or off depending on said temperature of said heater element in relation to a pre-selected temperature.

14. The closed-loop control circuit of claim 11, wherein said resistors are selected such that said bridge circuit is balanced when said temperature of said heater element is identical with a pre-selected value.

15. The closed-loop control circuit of claim 11, wherein scaling of said amplifier integrated circuit is set such that a gain of said amplifier integrated circuit sets a reaction and recovery rate for temperature changes of said heater element.

16. The closed-loop control circuit of claim 15, wherein said scaling of said amplifier integrated circuit is done with four additional resistors combined with said amplifier integrated circuit.

17. The closed-loop control circuit of claim 11, wherein said amplifier integrated circuit is a differential amplifier.

18. The closed-loop control circuit of claim 11, wherein said transistor is a field effect transistor.

19. The closed-loop control circuit of claim 11 further comprising a branch circuit for providing said supply voltage through a fifth resistor in said branch circuit for sensing a voltage when said transistor is off and not supplying a current to said bridge circuit.

20. A method for monitoring, controlling, and protecting a heater element having a positive temperature coefficient, comprising the steps of:
integrating said heater element into a bridge circuit that includes two branches;
integrating additional three resistors having known resistances into said bridge circuit such that each of said two branches includes two resistances;
providing a resultant bridge voltage of said bridge circuit to an amplifier integrated circuit;
controlling a transistor with said amplifier integrated circuit;
connecting said transistor with a battery voltage and said bridge circuit, such that a supply voltage that is essentially the same as said battery voltage is provided to said bridge circuit when said transistor is open; and
providing closed-loop control for said heater element.

21. The method of claim 20, further including the step of:
selecting said resistances of said resistors such that said two branches of said bridge circuit are balanced when said resistance of said heater element reaches a value that correlates with a pre-selected target temperature.

22. The method of claim 20, further including the steps of:
turning said transistor off when said resistance of said heater element is at or above a value that correlates with a pre-selected target temperature of said heater element; and
turning said transistor on when said resistance of said heater element is below a value that correlates with a pre-selected target temperature of said heater element.

23. The method of claim 20, further including the steps of:
replacing one of the resistors with a thermistor; and compensating said bridge circuit for ambient temperatures.
